(19) United States
(12) Patent Application Publication
(10) Pub. No.: US 2017/0210558 A1
(43) Pub. Date: Jul. 27, 2017

(54) RECEPTACLE SUPPORT DEVICE AND EXTENDER FOR RECEPTACLE AND METHOD THEREOF

(71) Applicant: CHRISTOPHER E. BOYEA, BURNT HILLS, NY (US)

(72) Inventor: CHRISTOPHER E. BOYEA, BURNT HILLS, NY (US)

(21) Appl. No.: 15/480,723

(22) Filed: Apr. 6, 2017

Related U.S. Application Data
(63) Continuation-in-part of application No. 14/818,175, filed on Aug. 4, 2015.
(60) Provisional application No. 62/032,875, filed on Aug. 4, 2014.

(51) Int. Cl. B65F 1/04; B65F 1/14; B65F 1/08

(52) U.S. Cl. CPC B65F 1/04; B65F 1/08; B65F 1/14

(57) ABSTRACT

A receptacle support device is provided. The receptacle may receive a garbage container and the garbage container may be secured to the receptacle support device such that the garbage container may receive waste materials.

### CROSS-REFERENCE TO RELATED APPLICATIONS

This application is a continuation in part of U.S. application Ser. No. 14/818,175, filed Aug. 4, 2015, and entitled “Extender for Receptacle and Method Thereof,” which claims priority to and the benefit of U.S. Provisional Application No. 62/032,875, filed Aug. 4, 2014, and entitled, “Extender for Receptacle.”

### FIELD OF TECHNOLOGY

The following relates to waste management disposal and containment, and more specifically to embodiments of a device that can increase the capacity of a standard receptacle, while also making garbage collection more efficient.

### BACKGROUND

Receptacles, such as garbage cans, typically come in standard sizes. In some households, the standard capacity of the garbage is exceeded before the garbage pickup is scheduled to come. This is especially true when a household hosts a party or an event that results in a larger than normal amount of garbage. The current solution is to stack the garbage next to the garbage can, or purchase an additional garbage can. Stacking the garbage next to the garbage perpetuates an odorous environment, is aesthetically unappealing, and adds labor time for the garbage collectors. Purchasing an additional garbage can take up extra space, can lead to additional charges from a garbage collection company, and may not be compatible with automated garbage trucks.

Thus, a need exists for an apparatus and method for increasing a capacity of a receptacle, storing an additional amount of garbage, and a method of disposal.

### SUMMARY

A first aspect relates generally to an extender for a receptacle, comprising: a plurality of walls, each of the plurality of walls being tapered from a first end of the extender to a second end of the extender, the plurality of walls being joined together to define an interior space for receiving waste materials, and at least one vertical slit located on one or more of the plurality of walls, the at least vertical slit permitting a deflection of a section of the one or more of the plurality walls, wherein the extender increases a storage capacity of the receptacle when the extender is inserted into an interior of the receptacle, the further the extender being inserted into the receptacle the stronger the friction fit between the receptacle and the extender due to the plurality of tapered walls.

A second aspect relates generally to an extender for increasing a storage capacity of a receptacle, comprising: a plurality of walls, the plurality of walls including a front wall, a back wall, a first side wall, and a second side wall, the plurality of walls being joined together to define an interior space for receiving waste materials, and at least one wing located on the first side wall of the plurality of walls, the at least one wing protruding a distance beyond a bottom edge of the first side wall, wherein, when the extender is placed atop the receptacle and external to an interior of the receptacle, the one or more wing is disposed within the interior of the receptacle.

A third aspect relates generally to a method for collecting garbage, comprising: providing a receptacle for storing waste materials, the receptacle configured to be lifted and inverted by a mechanical means of a garbage collection vehicle to empty the waste materials, providing an extender for use with the receptacle, the extender cooperating with the receptacle to increase a storage capacity of the provided receptacle, wherein the extender is disposable along with the waste materials, and at the same time, collecting the waste materials and the extender using the mechanical means of the garbage collection means.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a schematic view of a first embodiment of an extender located within an embodiment of a receptacle;

FIG. 2 depicts a perspective view of the first embodiment of an extender;

FIG. 3 depicts a perspective view of a second embodiment of an extender;

FIG. 4 depicts a perspective view of the second embodiment of an extender with an embodiment of a connection element;

FIG. 5 depicts a perspective view of an embodiment of an extender operably configured with an embodiment of a receptacle;

FIG. 6 depicts a sectional view of an embodiment of an extender operably configured with an embodiment of a receptacle;

FIG. 7 depicts a schematic view of a first position of a receptacle being lifted and inverted for removal of waste contents;

FIG. 8 depicts a schematic view of a second position of a receptacle being lifted and inverted for removal of waste contents;

FIG. 9 depicts a perspective view of a third embodiment of an extender;

FIG. 10 depicts a sectional view of the third embodiment of an extender;

FIG. 11 depicts a perspective view of the third embodiment of an extender having at least one structurally integral wing;

FIG. 12 depicts a sectional view of the third embodiment of an extender having one or more structurally integral wing;

FIG. 13 depicts a perspective view of the third embodiment of the extender operably configured with an embodiment of a receptacle;

FIG. 14 depicts a sectional view of the third embodiment of the extender operably configured with an embodiment of a receptacle;

FIG. 15 depicts a perspective view of an embodiment of a receptacle having a plurality of support elements;

FIG. 16 depicts a schematic view of a first position of a receptacle being lifted and inverted for removal of waste contents;

FIG. 17 depicts a schematic view of a second position of a receptacle being lifted and inverted for removal of waste contents;

FIG. 18 depicts a perspective view of a fourth embodiment of an extender operably configured with a receptacle;

FIG. 19 depicts a top view of the fourth embodiments of an extender operably configured with a receptacle;

FIG. 20 depicts a flowchart of an embodiment of a method;

FIG. 21 depicts a perspective view of an embodiment of a receptacle support device;

FIG. 22 depicts a side view of an embodiment of a receptacle support device;

FIG. 23 depicts a first perspective view of an embodiment of a receptacle support device with a garbage bag placed therein; and

FIG. 24 depicts a second perspective view of an embodiment of a receptacle support device with a garbage bag placed therein.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

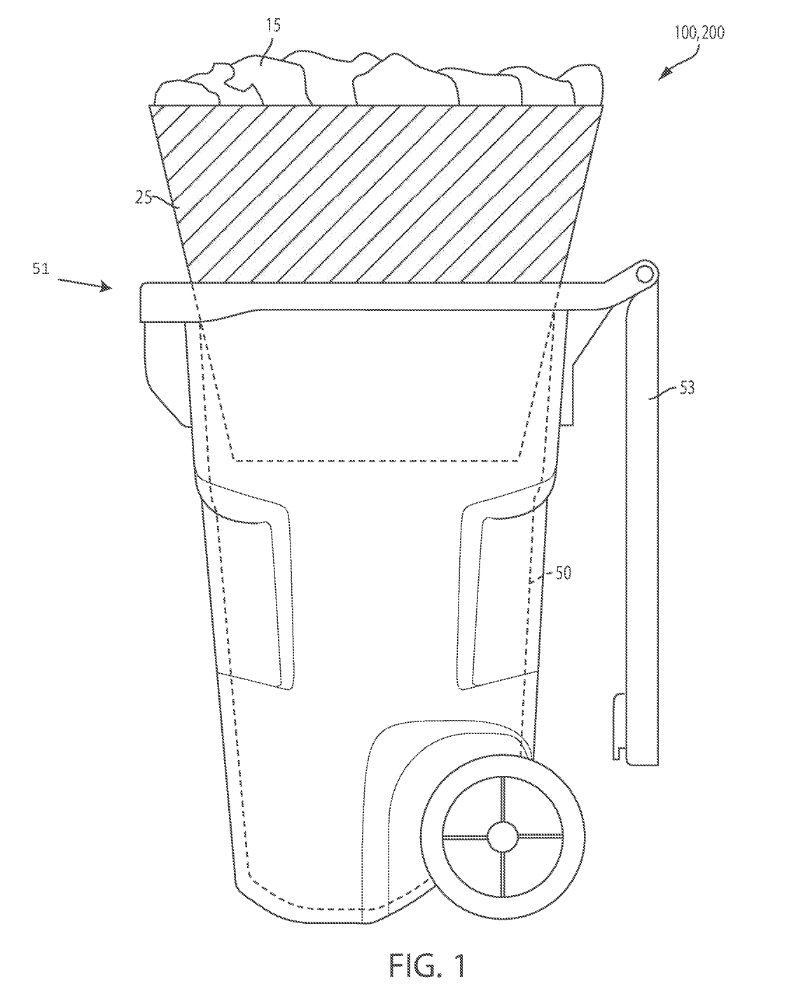

Referring to the drawings, FIG. 1 depicts an embodiment of an extender 100, 200 operably engaged with a receptacle 50. The extender 100, 200 may be a device that may be configured to be placed at least partially within a receptacle 50, such as industry standard sized garbage can, to extend or otherwise increase a capacity of the receptacle 50. The increased capacity, labeled as increased capacity 25 in FIG. 1, is an amount of volume for storing garbage, waste, yard waste, leaves, etc., or any contents suitable for placement in a receptacle that is in addition to a maximum volume afforded by the receptacle 50. For example, if the receptacle 50 becomes full of waste materials 15, such as garbage, waste, recyclables, yard waste, and the like, any additional waste materials will not fit properly within the receptacle 50, and likely fall to the side of the receptacle 50, or can blow away due to the wind or other environmental elements. To increase a volume or storage capacity of the receptacle 50, embodiments of an extender 100, 200 may be placed at least partially within the receptacle 50 so that additional waste materials 15 may be added to the waste material already within the receptacle 50. While the extender 100, 200 is operatively attached to the receptacle 50, a storage capacity of the receptacle 50 is effectively increased because of the walls of the extender 100 extending beyond a top end 51 of the receptacle 50. Embodiments of the receptacle 50 may be a garbage can, a pail, a garbage pail, a transportable waste container, a waste collection device, a barrel, a bucket, and the like. Embodiments of the receptacle 50 may be an industrial garbage can, and may be compatible with automatic garbage truck loaders, for example, receptacles provided by waste collection companies for scheduled pickup. In some embodiments, the receptacle 50 may include a cover 53 that can be hingedly or otherwise pivotally attached to the receptacle 50. Further, embodiments of receptacle 50 may be various sizes, as might be offered/provided by a waste collection company or a municipality, or otherwise available for purchase at a home improvement store.

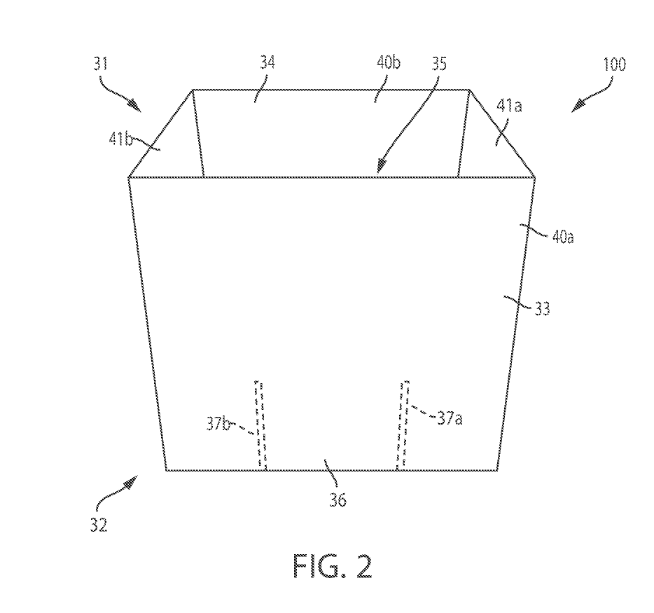

With continued reference to FIG. 1, an embodiment of extender 100 is depicted in FIG. 2. Embodiments of extender 100 may be an insert, a tapered box, a tapered structure, a garbage containment unit, a cardboard insert, or the like, sized and dimensioned to be placed within a receptacle 50 of various sizes. Embodiments of extender 100 may include a first end 31, a second end 32, an outer surface 33, an inner surface 34, and a general opening extending therethrough. Embodiments of extender 100 may be cone-shaped, and may be comprised of a single wall. Embodiments of the extender 100 may be tapered. For instance, embodiments of the extender 100 may taper in a direction from the first end 31 toward a second end 32, such that a width of the extender 100 may gradually decrease from the first end 31 to the second end 32. A tapered structure or configuration of the extender 100 may ensure or promote a friction fit with the receptacle 50 as the extender 100 is lowered or otherwise placed within an interior of the receptacle 50. The tapered configuration may also accommodate various sizes of an interior of various receptacles 50. Further embodiments of the extender 100 may include a tapered section proximate or otherwise near the second end 32, wherein a portion of the extender 100 (e.g. proximate or otherwise near the first end 31) is not tapered, and only begins to taper at a point proximate or otherwise near the second end 32.

Moreover, embodiments of the extender 100 may include a plurality of walls 40a, 40b, 41a, 41b. The plurality of walls 40a, 40b, 41a, 41b may form or otherwise define an interior space 35 of the extender 100. Each of the plurality of walls 40a, 40b, 41a, 41b may be shaped like a trapezoid to facilitate the tapered shape/configuration of the extender 100. A number and an arrangement of the plurality of walls, when operably configured, may correspond to a geometric shape of an opening of the receptacle 50 so that it may at least partially fit within the receptacle 50. In one embodiment, the extender 100 may include four walls, with a front wall 40a, a back wall 40b, a first side wall 41a, and a second side wall 41b. The walls 40a, 40b, 41a, 41b may be equal in size, or may vary in size with respect to each other. Furthermore, the walls 40a, 40b, 41a, 41b may be structurally integral with each other and joined along each edge to the next wall, as shown in FIG. 2. The edges may be creased or pre-creased to facilitate or promote flexibility of the extender 100. The flexibility of the extender 100 may vary, but in some cases, the extender 100 may be able to be folded into a flat unit, while all of the edges of the walls 40a, 40b, 41, 41b remain connected, structurally integral or otherwise.

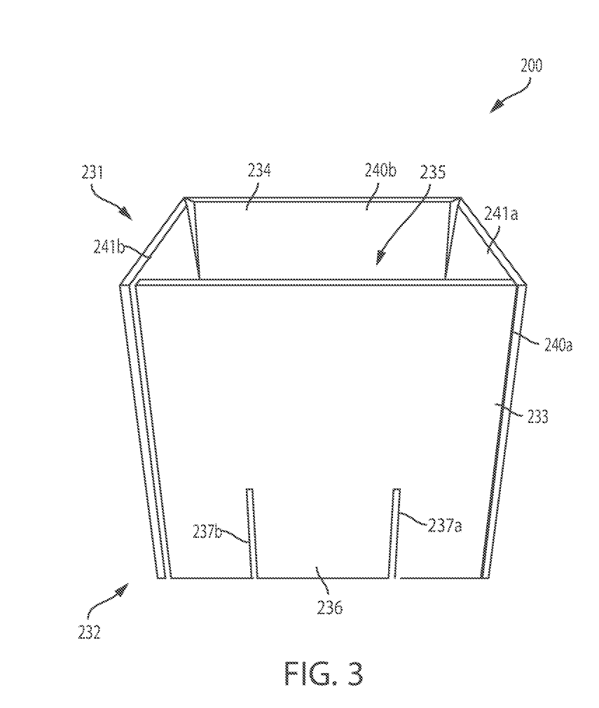

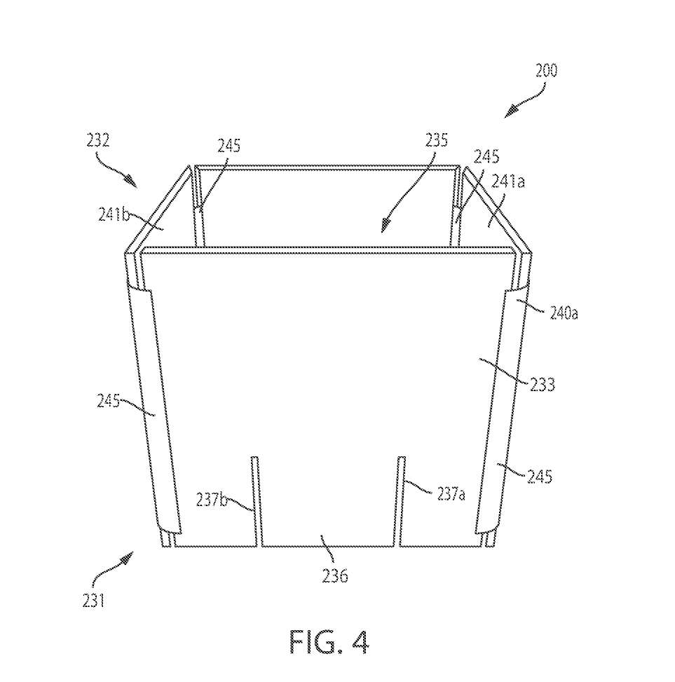

FIG. 3 depicts an embodiment of extender 200. Embodiments of extender 200 may share the same or substantially the same structural and functional aspects of extender 100, including a first end 231, a second end 232, an outer surface 233, and inner surface 234, a general opening therethrough, and an interior space 235. However, extender 200 may include at least one edge of one of the plurality of walls 240a, 240b, 241a, 241b may be a free edge, which may also allow the extender 200 to be packaged and sold as a flat, or relatively flat, or a folded flat unit. For example, a left edge of front wall 240a may be a free edge, while the other, right, edge of the front wall 240a is connected to the left edge of first side wall 241a. In this example, an edge of the second side wall 41b may also be a free edge. Any configuration or combination of free edges may be implemented to form extender 200. In some operable configurations, such as shown in FIG. 4, the free edges may be connected to each other for added stability once ready for use. For instance, the free edges may be connected to each other using a connection element 245. Embodiments of connection element 245 may be an adhesive tape, such as duct tape, staples, glue, clap, or other suitable material or component that may join two edges of the walls 240a, 240b, 241a, 241b together. In other operable configurations, the free edges may remain unconnected when placed within the receptacle 50, wherein the free edges are proximate or otherwise near each other when in this operable configuration.

With continued reference to FIGS. 2-4, embodiments of extender 100, 200 may also include a deflection flap 36, 236. Embodiments of deflection flap 36, 236 may be a section of the extender 100, 200 of one or more walls of extender 100, 200 that may deflect inward or outward to accommodate various sizes of receptacle 50. The deflection, inward or outward, may further promote or otherwise ensure a friction fit between an inner surface of the receptacle 50 and the extender 100, 200. For example, receptacle 50 may have various interior shapes (e.g. protrusions, etc.) that may engage portions of the extender 100, 200 with a different force than another area of the extender 100, 200. The deflection flap or deflection portion 36, 236 may deflect or otherwise move inwardly or outwardly to increase a mechanical interference or friction fit between the receptacle 50 and the extender 100, 200 to compensate for looser connections between the receptacle 50 and the extender 100, 200 in other areas. The deflection of the flap 36, 236 may also be affected by waste materials already within receptacle 50, which may also promote friction fit between the extender 100, 200 and the receptacle 50. Embodiments of the deflection flap 36, 236 may be formed by one or more vertical slits 237a, 237b extending from a second end 32, 232 of the extender 100, 200 a distance towards the first end 32, 232. The vertical slits may permit deflection inwardly or outwardly, as described above. The vertical slits 237a, 237b may be perforations, or may be a continuous cut into the extender 100, 200. Furthermore, embodiments of the extender 100, 200 may be made out of cardboard or other suitable material. The material(s) forming the extender 100, 200 may be disposable. However, in some embodiments, the extender 100, 200 may be made of a material that can be reused without significant risk of damage if exposed to environmental elements. In further embodiments, the extender 100, 200 may be made out a metal, such as aluminum, or plastic and can be recycled with the other contents within the receptacle 50, such as known recyclable items that are commonly discarded.

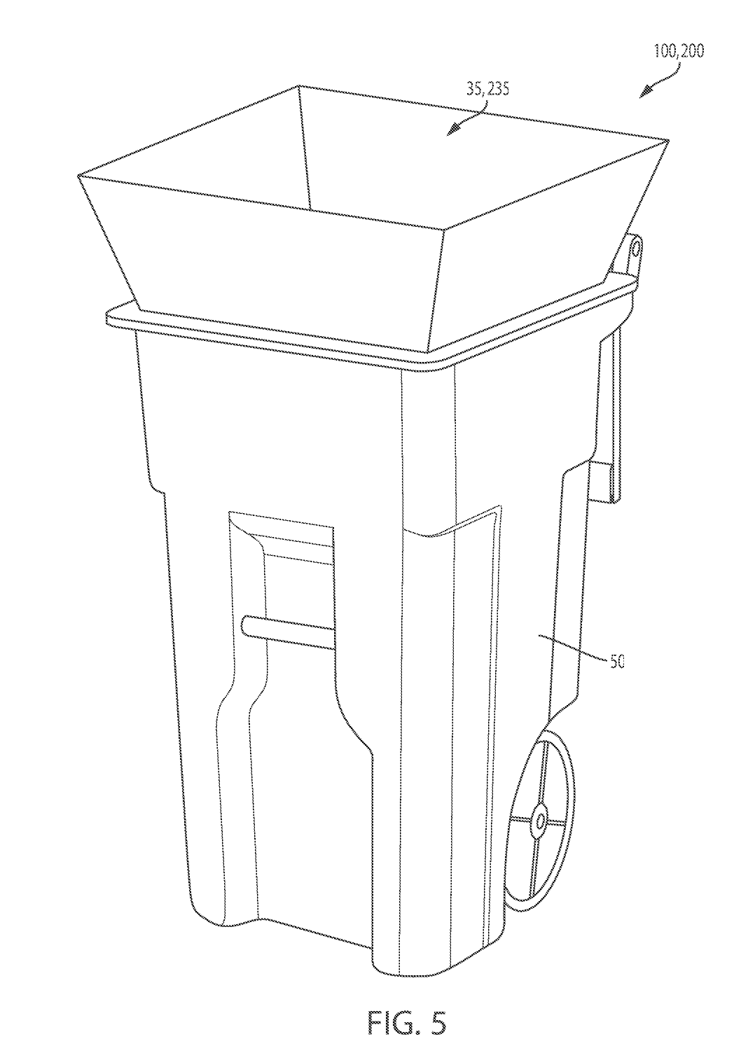

Referring now to FIGS. 5 and 6, embodiments of extender 100, 200 are shown in an operable configuration and engaged with receptacle 50. The extender 100, 200 may be provided to an end user as a flat and/or folded unit, as described above, or may be provided to an end user partly folded or otherwise intact. If the extender 100, 200 comes in a folded or flat unit, a user may manipulate the plurality of walls 40a, 40b, 41a, 41b to form a box-like structure, as shown in FIGS. 5 and 6. Once assembled or otherwise formed into a box-like structure, the extender 100, 200 may be inserted within an interior 55 of the receptacle 50. Embodiments of the extender 100, 200 may be placed within the receptacle 50 from a top end 51 and driven further into the interior 55 of the receptacle 50. Because embodiments of the extender 100, 200 may be tapered, further displacement into the interior 55 of the receptacle 50 eventually results in mechanical interference between the walls 40a, 40b, 41a, 41b, or one or more deflection flaps 36, 236, and an inner surface 54 of the receptacle 50. The extender 100, 200 may be driven/pushed, forced, placed, etc. into the interior 55 of the receptacle 50 a distance, hᵣ, so as to provide a friction fit between the two components to prevent, hinder, or impede dislocation of the extender 100, 200 while the receptacle 50 is an upright, storage/collection position, as shown in FIGS. 5 and 6. In some embodiments, the extender 100, 200 may include a lip, edge, protrusion, or other surface feature that extends perpendicularly or substantially perpendicularly from an inner surface 34, 234 proximate, at, or otherwise near the second end 32, 232. The lip or engagement surface may extend perpendicularly into a center of the interior space 35, 235 so that waste materials 15 added into the extender 100, 200 may engage the lip to further hinder dislocation of the extender 100, 200 from the receptacle 50. The lip may be bent inwards by a user or may come perforated or creased for easy folding. The distance, represented by hᵣ, the extender 100, 200 enters the interior 55 of the receptacle 50 may vary and may depend on a size of the receptacle 50. In this position, the extender 100, 200 may be physically pulled out from and removed from the receptacle 50 by a user, but may be able to withstand other external forces such as wind, rain, addition of waste materials 55 to the receptacle, and the like. Furthermore, in this position, the extender 100, 200 may protrude, extend, or otherwise rise from a top end 51 of the receptacle 50 a distance, hₑ, which may represent an increased storage capacity for waste materials 15. For instance, when waste materials 15 fill or substantially fill the interior 55 of the receptacle 50, the extender 100, 200 may be utilized to add an additional storage volume to the receptacle 50. The volume added depends on the distance, hₑ, or height, the walls 40a, 40b, 41a, 41b extend from a top end 51 of the receptacle 50, as well as the width of each of the walls 40a, 40b, 41a, 41b. Thus, additional waste materials 15 (i.e. in addition to waste materials 15 already stored or located within the interior 15 of the receptacle 50) may be collected, stored, accommodated, received, etc. between the walls 40a, 40b, 41, 41b of the extender 100, 200, when the extender 100, 200 is engaged with the receptacle 50.

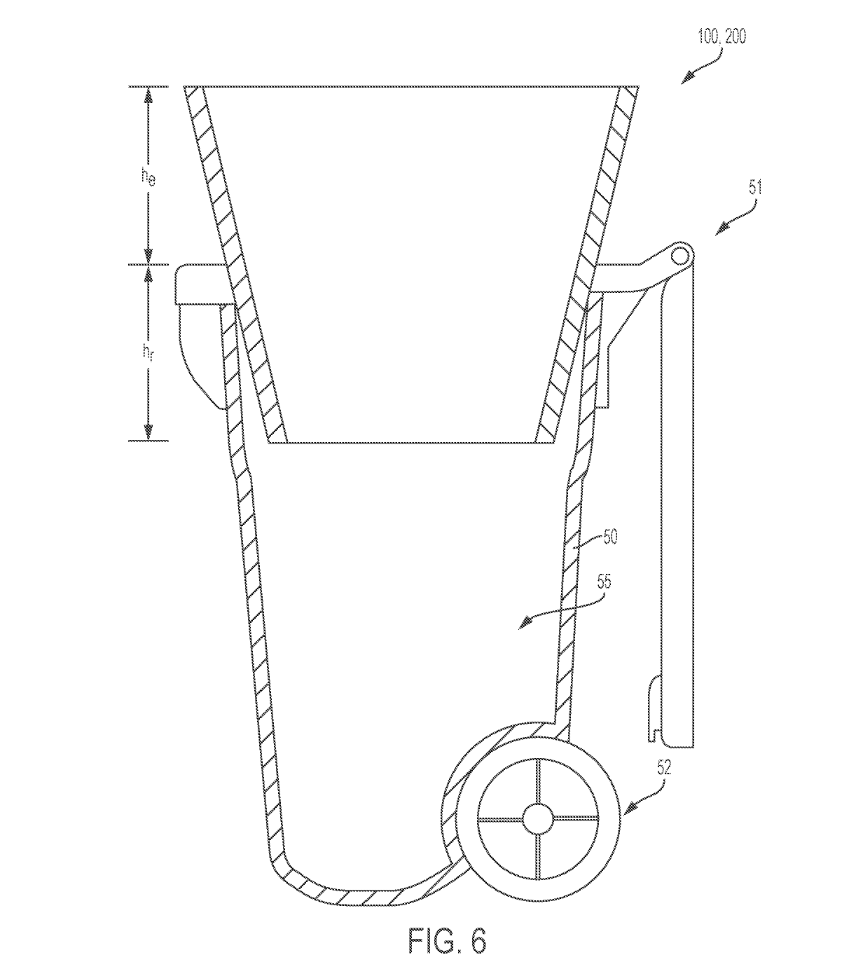

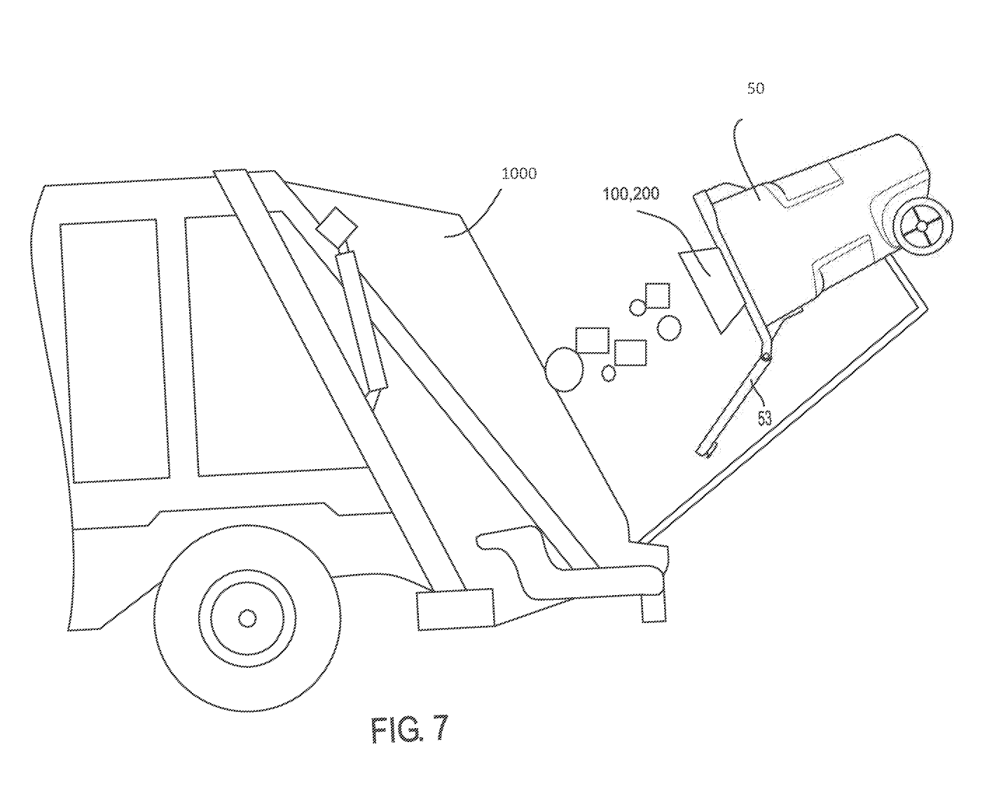

With reference now to FIGS. 7 and 8, a manner in which the waste materials 15 and the extender 100, 200 may be disposed is now described. While the receptacle 50 is in an upright, collection position, with the extender 100, 200 operably engaged with the receptacle 50, waste materials 15 may be collected and stored for eventual pickup and removal by a garbage removal company or municipality service. When it comes time for the waste materials 15 to be picked up and removed, the garbage collectors may utilize a collection vehicle 1000, such as a garbage truck, to secure, grab, or otherwise manipulate the receptacle 50 to invert, at least to some degree, the receptacle 50 to allow the waste materials 15 to exit the interior 55 of the receptacle 50 and into a collection area of the collection vehicle 1000. As shown in FIG. 7, an initial amount or portion of the waste materials 15 may exit the extender 100, 200 and/or the receptacle 50 and into the collection area of the collection vehicle 1000. As the waste materials 15 continue to exit the receptacle 50, a weight of the remaining waste materials 15 passing by the extender 100, 200 may engage the extender 100, 200, for example, may engage an internal lip of the extender 100, 200 proximate the second end 32, 232, and may help drive or otherwise urge the extender 100, 200 out of physical engagement with the inner surface 55 of the receptacle 50, and into the collection area of the collection vehicle 100 along with other waste materials 15, as shown in FIG. 8. Therefore, the waste materials 15 and the extender 100, 200 are efficiently disposed of and collected in a single motion—or a single lift and invert of the receptacle 50. This may save time for the garbage collectors because they do not need to stop, bend over, and hand collect waste material stacked next to the receptacle 50 because the receptacle 50 lacked the capacity to store all of the waste. Further, no additional time may be wasted to collect the additional waste materials 15 collected/stored by the presence/use of the extender 100, 200 because the extender 100, 200 may be disposed of and collected by the garbage collection vehicle 1000 in the same motion as if just collecting the waste stored in the receptacle 50.

In alternative embodiments, a garbage collector(s) may physically lift and invert the receptacle 50 with the extender 100, 200 attached thereto and empty into a garbage collection vehicle 1000, or suitable collection means. The extender 100, 200 may likewise disengage from the receptacle 50 for disposal along with the waste materials 15.

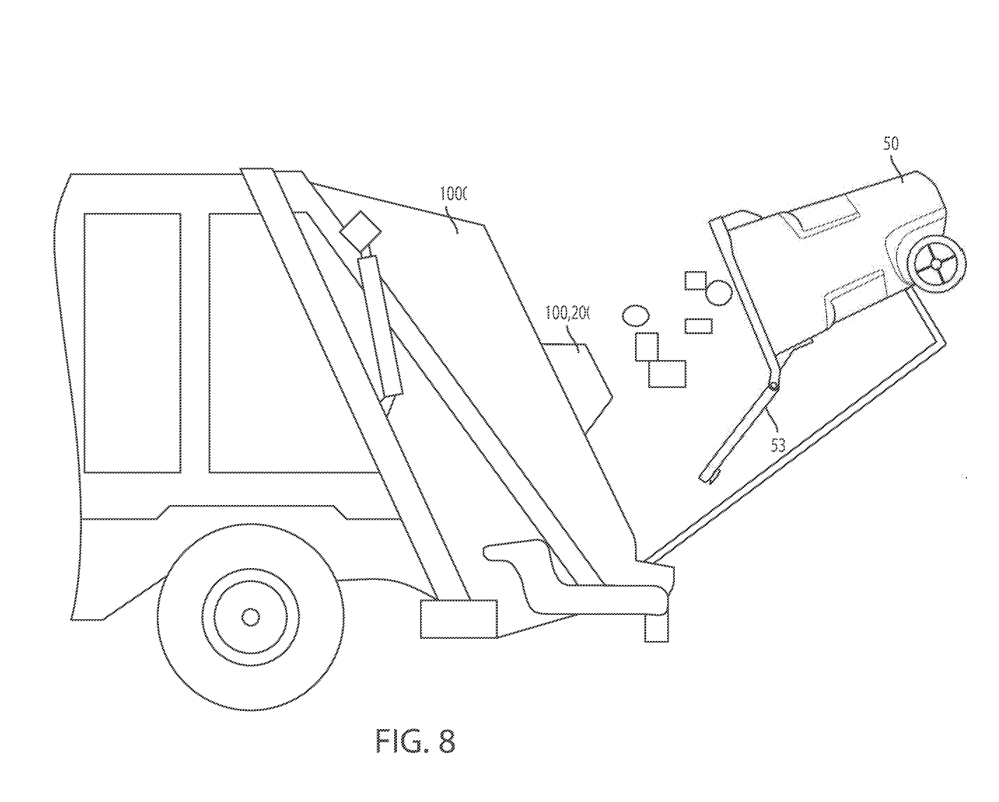

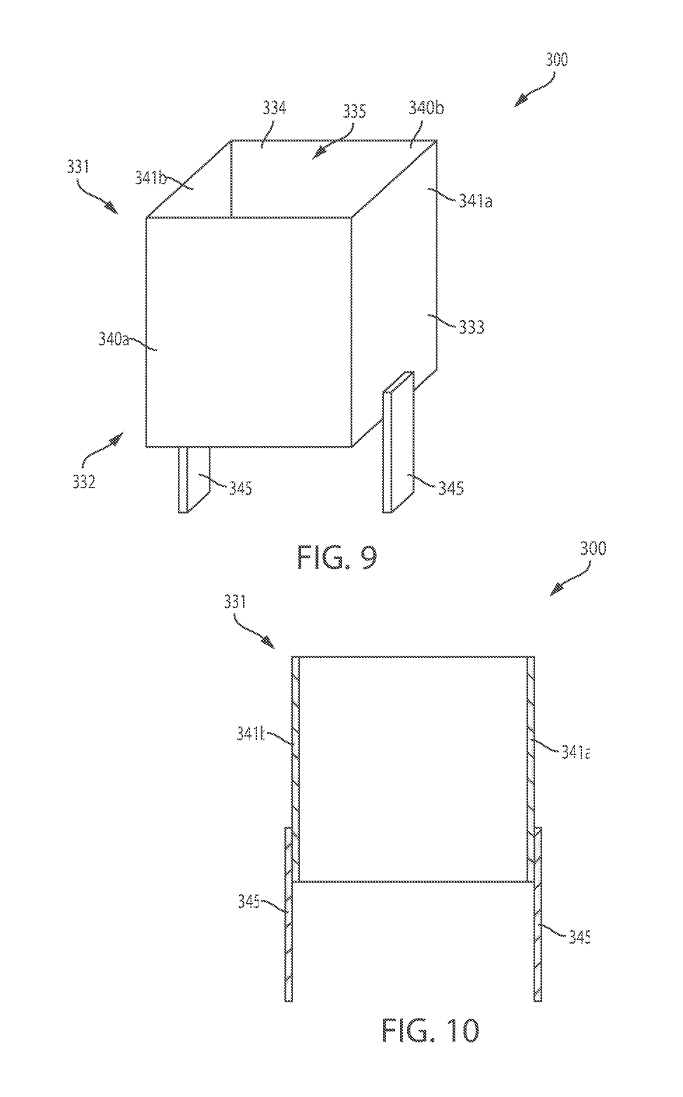

With continued reference to the drawings, FIGS. 9 and 10 depict an embodiment of extender 300. Embodiments of extender 300 may be a box, an add-on, a cardboard structure, a garbage containment unit, a cardboard accessory, or the like, sized and dimensioned to be placed on top of a cover 53 of a receptacle 50 of various sizes. The extender 300 may be a device that may be configured to be placed upon a cover 53 of a receptacle 50, such as industry standard sized garbage can, to extend or otherwise increase a capacity of the receptacle 50. The increased capacity may be an amount of volume for storing garbage, waste, yard waste, leaves, etc., or any contents suitable for placement in a receptacle that is in addition to a maximum volume afforded by the receptacle 50. For example, if the receptacle 50 becomes full of waste materials 15, such as garbage, waste, recyclables, yard waste, and the like, any additional waste materials will not fit properly within the receptacle 50, and likely fall to the side of the receptacle 50, or can blow away due to the wind or other environmental elements. To increase a volume or storage capacity of the receptacle 50, embodiments of an extender 300 may be placed on a top of a receptacle 50 so that additional waste materials 15 may be stored in addition to the waste material already stored within the receptacle 50. While the extender 300 is operatively attached to the receptacle 50, a storage capacity of the receptacle 50 is effectively increased because of the additional capacity or volume afforded by the extender 300. Embodiments of the receptacle 50 may be a garbage can, a pail, a garbage pail, a transportable waste container, a waste collection device, a barrel, a bucket, and the like. In some embodiments, the receptacle 50 may include a cover 53 that can be hingedly or otherwise pivotally attached to the receptacle 50. Further, embodiments of receptacle 50 may be various sizes, as might be offered/provided by a waste collection company or a municipality, or otherwise available for purchase at a home improvement store.

Embodiments of extender 300 may include a first end 331, a second end 332, an outer surface 333, an inner surface 334, and a general opening extending therethrough. Moreover, embodiments of the extender 300 may include a plurality of walls 340a, 340b, 341a, 341b. Each of the plurality of walls 340a, 340b, 341a, 341b may be shaped like a square or rectangle to form a box-like configuration having an interior space 335. A number and an arrangement of the plurality of walls, when operably configured, may correspond to a geometric shape of a cover 53 of the receptacle 50 so that it may efficiently rest upon a cover 53 of the receptacle 50. In one embodiment, the extender 300 may include four walls, with a front wall 340a, a back wall 340b, a first side wall 341a, and a second side wall 341b; embodiments of the extender 300 may include an optional bottom wall and/or a top wall, wherein the top wall may be opened when needed to place contents therein and closed to hinder access, provide protection against rain or other environmental elements, and/or minimize odor. For instance, a top wall may be movably or pivotally attached to the at least on the walls 340a, 34b, 341a, 341b. The walls 340a, 340b, 341a, 341b may be equal in size, or may vary in size with respect to each other. Furthermore, the walls 340a, 340b, 341a, 341b may be structurally integral with each other and joined along each edge to the next wall, as shown in FIG. 9. The edges may be creased or pre-creased to facilitate or promote flexibility of the extender 300. The flexibility of the extender 100 may vary, but in some cases, the extender 300 may be able to be folded into a flat unit, while all of the edges of the walls 340a, 340b, 341, 341b remain connected, structurally integral or otherwise.

Furthermore, embodiments of extender 300 may include at least one edge of one of the plurality of walls 340a, 340b, 341a, 341b may be a free edge, which may also allow the extender 300 to be packaged and sold as a flat, or relatively flat, or a folded flat unit. For example, a left edge of front wall 340a may be a free edge, while the other, right, edge of the front wall 340a is connected to the left edge of first side wall 341a. In this example, an edge of the second side wall 341b may also be a free edge. Any configuration or combination of free edges may be implemented to form extender 300. In some operable configurations, the free edges may be connected to each other for added stability once ready for use. For instance, the free edges may be connected to each other using a connection element, such as a component similar to connection element 245 described supra. In other operable configurations, the free edges may remain unconnected when placed within the receptacle 50, wherein the free edges are proximate or otherwise near each other when in this operable configuration.

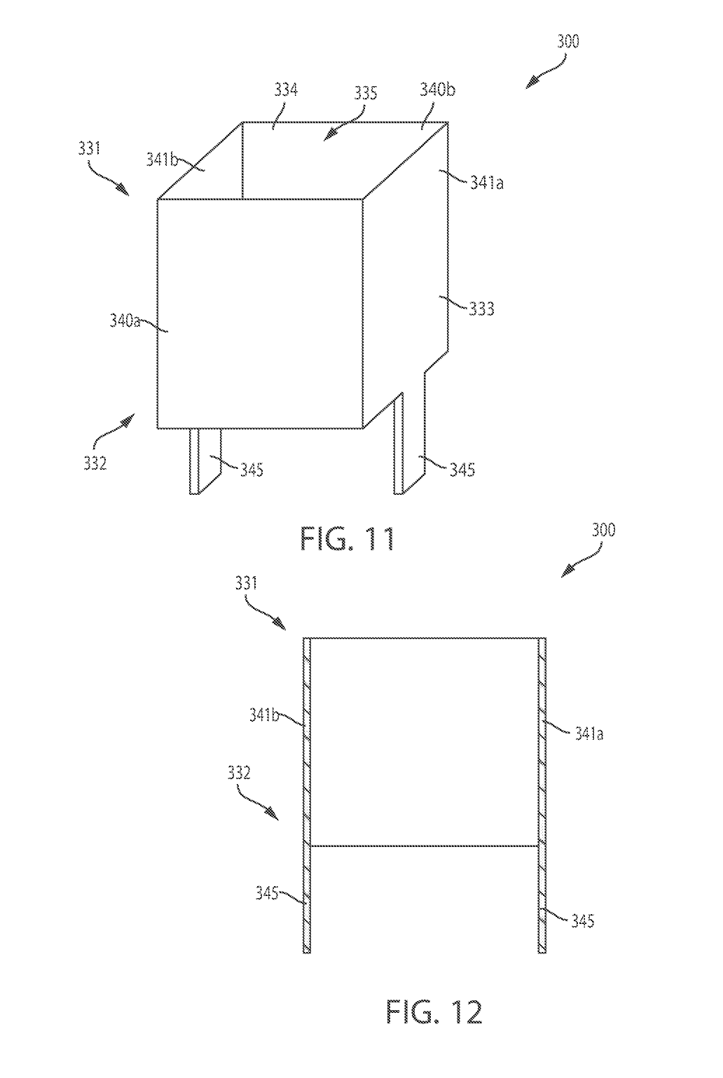

Referring still to FIGS. 9 and 10, embodiments of extender 300 may include one or more wings 345. Embodiments of the one or more wings 345 may be a wing, a strap, a flap, a connector, a securing strap, a securing element, and the like. Embodiments of the one or more wings 345 may be a separate section of material that is operably attached to one or more walls, such a first side wall 341a and a second side wall 341b. For example, wings 345 may be affixed, adhered, stapled, or otherwise secured to one or more side walls of the extender 300. Alternatively, embodiments of wings 345 may be structurally integral with one or walls 340a, 340b, 341a, 341b of the extender 300, as shown in FIGS. 11 and 12. Embodiments of the one or more wings 345 may protrude, extend, or hang down beyond a second end 332 of the extender 300 a distance to allow the wings 345 to be manipulated for operable engagement with the receptacle 50. Furthermore, embodiments of the extender 300 may be made out of cardboard or other suitable material. The material(s) forming the extender 300 may be disposable. However, in some embodiments, the extender 300 may be made of a material that can be reused without significant risk of damage if exposed to environmental elements. In further embodiments, the extender 300 may be made out a metal, such as aluminum, or plastic and can be recycled with the other contents within the receptacle 50, such as known recyclable items that are commonly discarded. In even further embodiments, waste materials 15 may be segregated by type/contents by locating certain materials in the extender 300, and the more conventional or non-hazardous contents in the interior 55 of the receptacle 50. For example, normal waste materials 15 may be kept in the receptacle 50, while batteries may be placed within the interior space 335 of the extender 300 to separate the contents, making it easier for collection companies to sort contents. Sorting contents may be made easier because the contents of extender 300 may be dumped into a separate compartment of the collection vehicle 1000 (e.g. recyclables, hazardous, etc.)

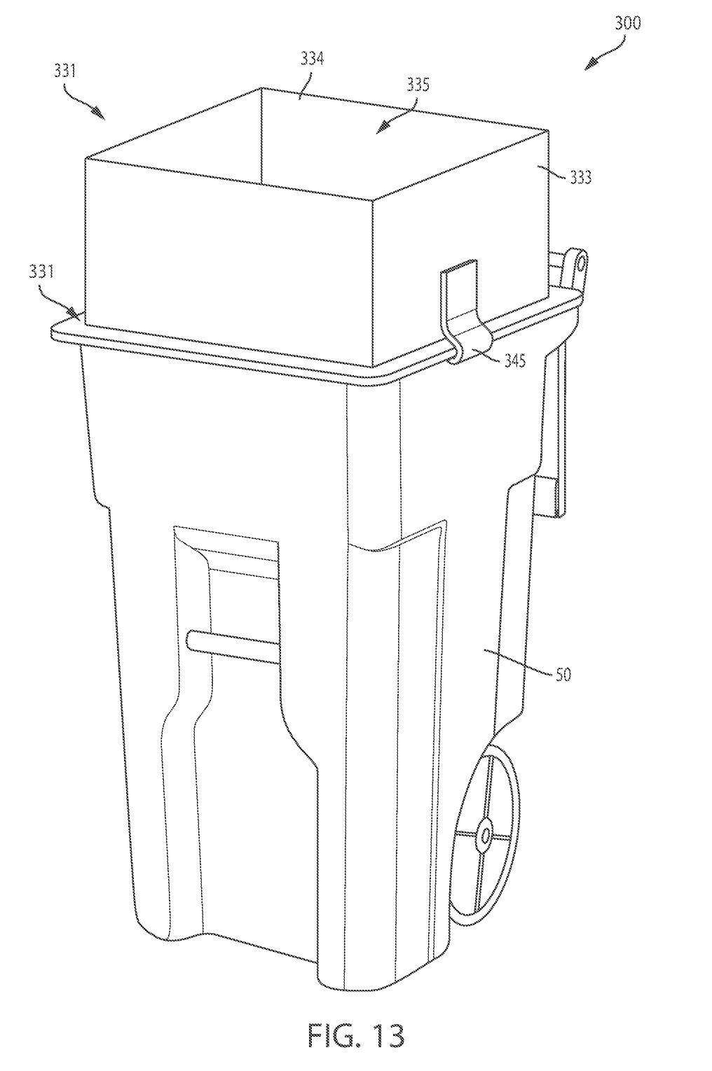

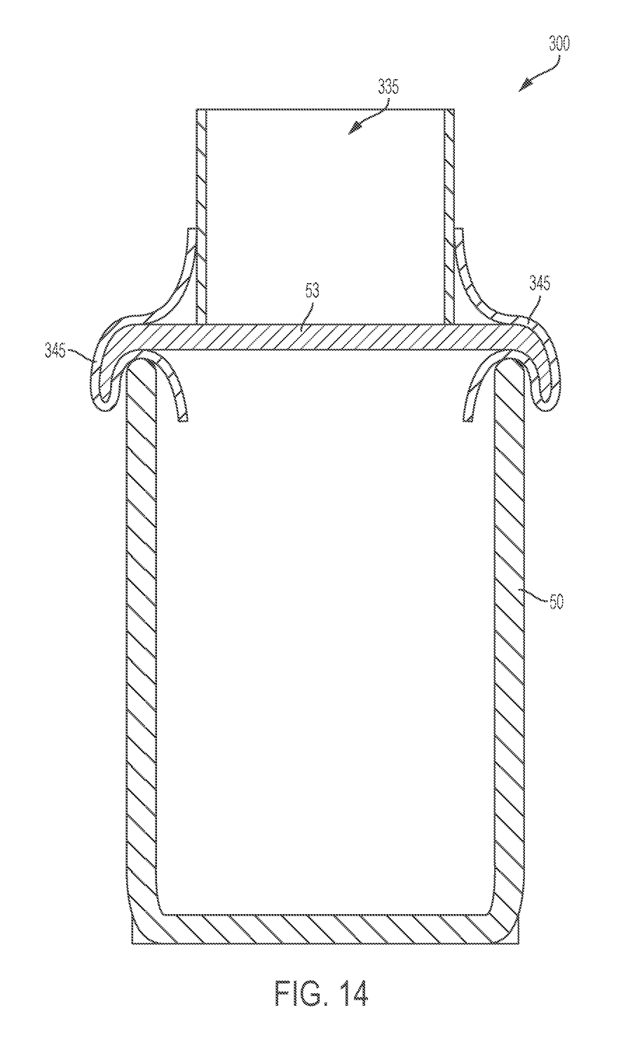

Referring now to FIGS. 13 and 14, an embodiment of extender 300 is shown in an operable configuration and engaged with receptacle 50. The extender 300 may be provided to an end user as a flat and/or folded unit, as described above, or may be provided to an end user partly folded or otherwise intact. If the extender 300 comes in a folded or flat unit, a user may manipulate the plurality of walls 340a, 340b, 341a, 341b to form a box-like structure, as shown in FIGS. 8-11. Once assembled or otherwise formed into a box-like structure, the extender 300 may be placed on a cover 53 of a receptacle 50 (e.g. when the cover 53 is closed over a top end 51 of the receptacle 50). Because the one or more wings 345 may protrude, extend, or hang down beyond a second end 332 of the extender 300 a distance, the wings 345 may be manipulated so as to be placed underneath a cover 53 of the receptacle 50 and into an interior 55 of the receptacle 50. For instance, a user may place the extender 300 on top of the receptacle 50, and at least slightly open the cover 53, and when the cover 52 is at least slightly open, the user may insert the one or more wings 345 into the interior 55 of the receptacle 50, and then return the cover 53 to a closed position. A weight of the cover 53 may secure the extender 300 in a collection position atop the receptacle 50, thus affording the receptacle 50 an increased storage capacity for waste materials 15. As more waste materials 15 are placed within the interior space 335 of the extender 300, an additional weight/force can be applied to the cover 53, thus increasing the force exerted against the one or more wings 345.

Accordingly, in this position, the extender 300 may protrude, extend, or otherwise rise from a top cover 53 of the receptacle 50 a distance, which may represent an increased storage capacity for waste materials 15. For instance, when waste materials 15 fill or substantially fill the interior 55 of the receptacle 50, the extender 300 may be utilized to add an additional storage volume to the receptacle 50. The volume added depends on the distance, or height, the walls 340a, 340b, 341a, 341b extend from a top end 51 of the receptacle 50, as well as the width of each of the walls 340a, 340b, 341a, 341b. Thus, additional waste materials 15 (i.e. in addition to waste materials 15 already stored or located within the interior 15 of the receptacle 50) may be collected, stored, accommodated, received, etc. between the walls 340a, 340b, 341, 341b of the extender 300, when the extender 300 is engaged with the receptacle 50.

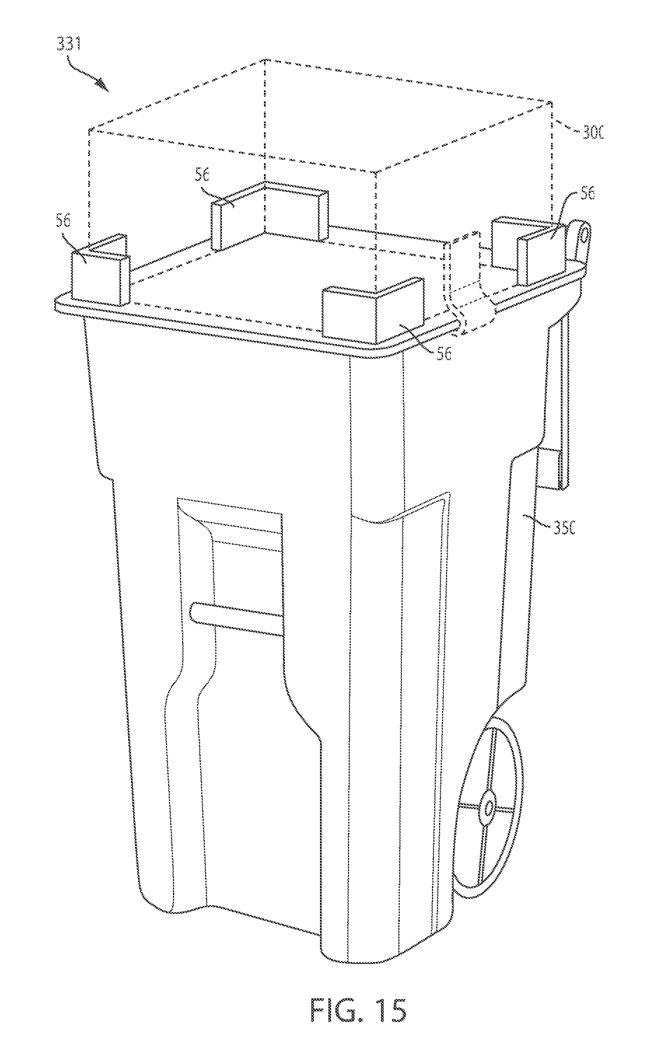

FIG. 15 depicts an embodiment of a receptacle 50 that may include a plurality of support elements 56. Embodiments of support elements 56 may be supports, box supports, extender supporters, framing elements, guide elements, corner elements, or any suitable component for preventing or hindering slidable movement of the extender 300 across the cover 53 of the receptacle 50 when placed atop the receptacle 50. Embodiments of the support elements 56 may be positioned in or more corner locations of the cover 53 of the receptacle 50. Additionally, support elements 56 may be positioned on the cover 53 at a location that may correspond to where a wall 340a, 340b, 341a, 341b engage the cover 53 of the receptacle 50. Embodiments of the support elements 56 may include a right angle or a substantially right angle to accommodate or correspond with a corner of the extender 300. Embodiments of the support elements 56 may include a first wall and a second wall, or a single wall, that may protrude or extend upwards from the cover 53 of the receptacle. Thus, an extender 300 may be placed between the support elements 56, wherein the support elements 56 may prevent or hinder slidable movement of the extender 300 to help retain the extender 300 in position. Further, embodiments of the support elements 56 may be structurally integral with the cover 53, or may be separately attached to the cover 53, and may be made of the same or different material of the cover 53. In most embodiments, the support elements 56 may be comprised of a rigid material.

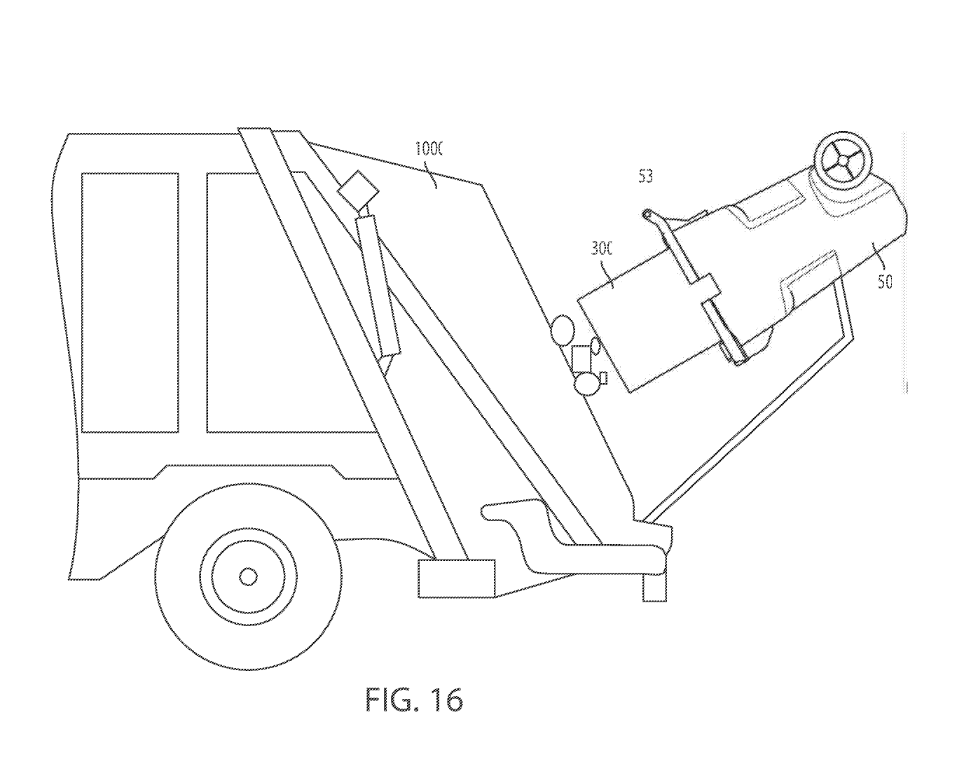

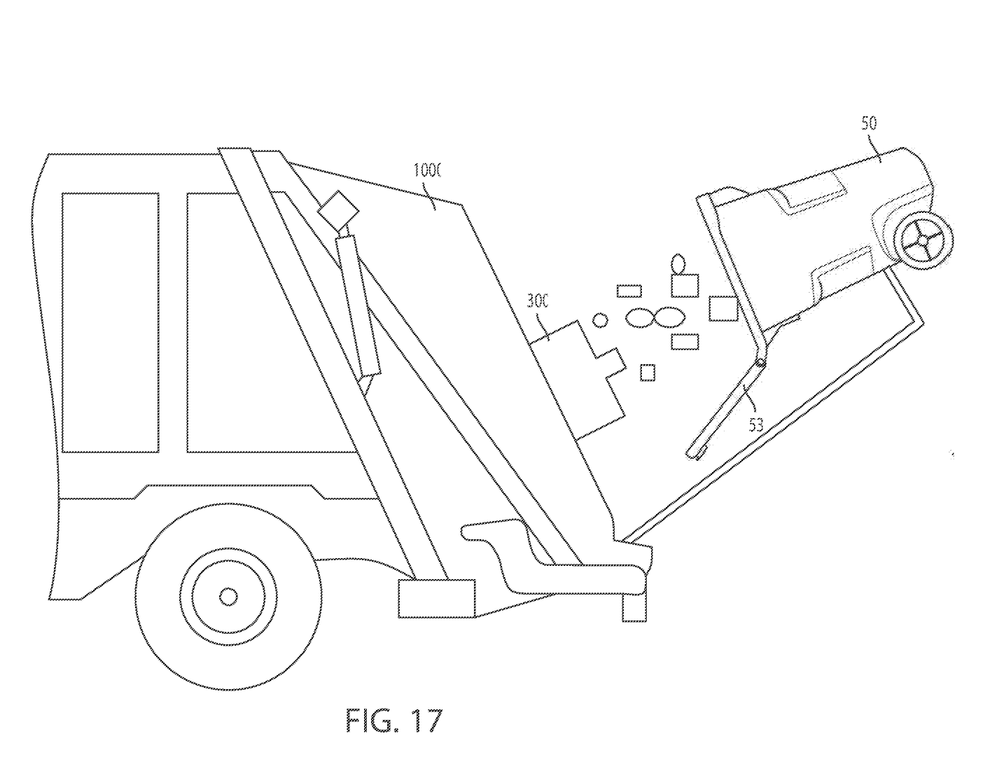

With reference now to FIGS. 16 and 17, a manner in which the waste materials 15 and the extender 300 may be disposed is now described. While the receptacle 50 is in an upright, collection position, with the extender 300 operably engaged with the receptacle 50, waste materials 15 may be collected and stored for eventual pickup and removal by a garbage removal company or municipality service. When it comes time for the waste materials 15 to be picked up and removed, the garbage collectors may utilize a collection vehicle 1000, such as a garbage truck, to secure, grab, or otherwise manipulate the receptacle 50 to invert, at least to some degree, the receptacle 50 to allow the waste materials 15 to exit the interior 55 of the receptacle 50 and into a collection area of the collection vehicle 1000. As shown in FIG. 15, an initial amount or portion of the waste materials 15 may exit the extender 300 into the collection area of the collection area. As the waste materials 15 exit the extender 300 and the receptacle 50 is at least partially inverted, the cover 53 also begins to open, releasing the one or more wings 345 of extender 300. When the one or more wings 345 are released (i.e. the cover 53 no longer pinches the wings 345 against a top lip of the receptacle 50), the extender 300 is physically disengaged with the receptacle 50, and drops into the collection area of the collection vehicle 100 along with other waste materials 15, as shown in FIG. 16. Therefore, the waste materials 15 and the extender 300 are efficiently disposed of and collected in a single motion—or a single lift and invert of the receptacle 50. This may save time for the garbage collectors because they do not need to stop, bend over, and hand collect waste material stacked next to the receptacle 50 because the receptacle 50 lacked the capacity to store all of the waste. Further, no additional time may be wasted to collect the additional waste materials 15 collected/stored by the presence/use of the extender 300 because the extender 300 may be disposed of and collected by the garbage collection vehicle 1000 in the same motion as if just collecting the waste stored in the receptacle 50.

In alternative embodiments, a garbage collector(s) may physically lift and invert the receptacle 50 with the extender 300 attached thereto and empty into a garbage collection vehicle 1000, or suitable collection means. The extender 300 may likewise disengage from the receptacle 50 for disposal along with the waste materials 15.

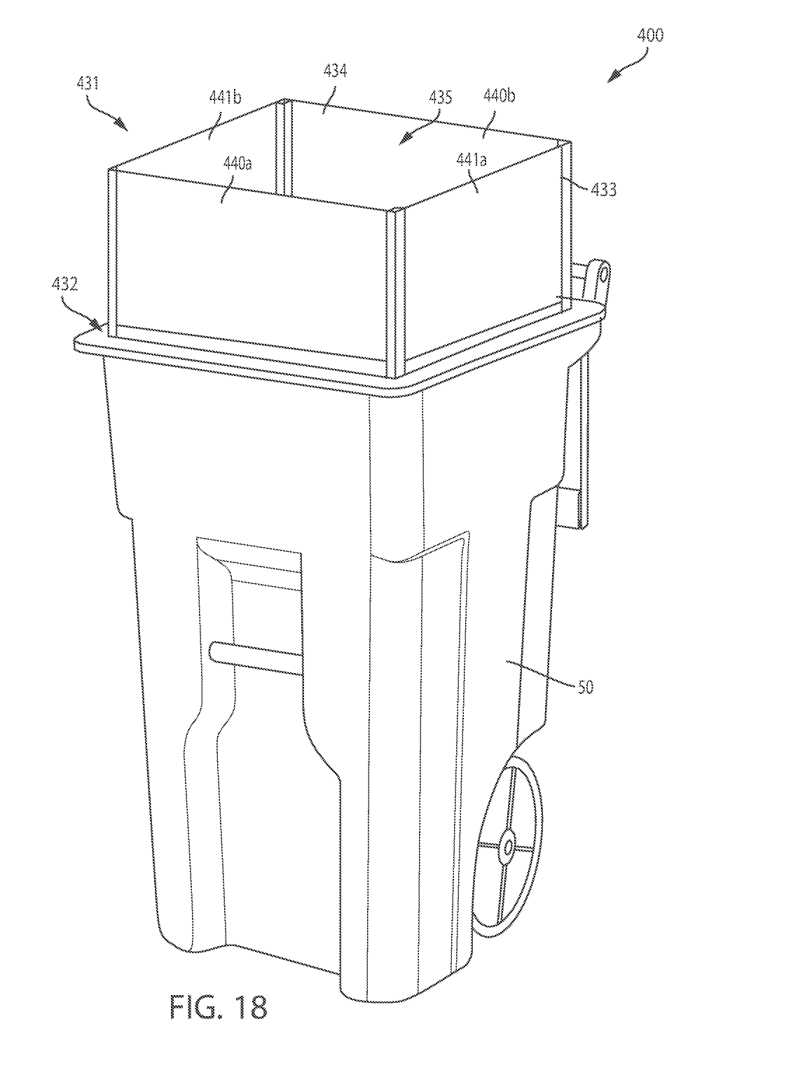

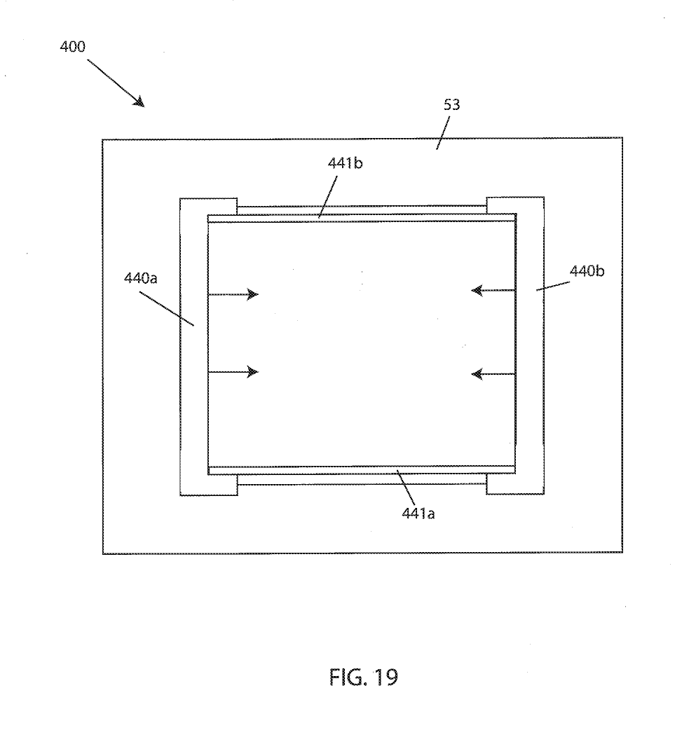

FIGS. 18 and 19 depict yet another embodiment of an extender 400. Embodiments of extender 400 may be permanently attached to a receptacle 50. For instance, embodiments of extender 400 may be permanently attached to a cover 53 of the receptacle 50. Embodiments of extender 400 may be collapsible, such that when additional storage capacity is not needed, the extender 400 may be collapsed into a first, flat position, and when needed to increase a storage capacity of the receptacle 50, the extender 50 may be unfolded or moved to a second, erect position. Moreover, embodiments of the extender 400 may include a plurality of walls 440a, 440b, 441a, 441b, an outer surface 433, and inner surface 434, and an interior space 435 to accommodate waste materials 15. At least two of the walls 440a, 440b, 441a, 441b may be spring loaded and hingedly movable from a flat position to an upright, erect position. While the spring loaded walls are held erect or partially erect, another wall, which may not be spring loaded, can be raised to fit between the spring loaded wall. The force of the spring loaded wall acting on either side of the free standing wall will keep the walls erect, and in the second, upright position configured to received and store waste materials 15 beyond or in addition to the waste materials 15 stored within the receptacle 50. A remaining wall, which may not be spring loaded, may also be lifted upright so as to fit between the spring loaded walls to complete the extender 400. While embodiments of extender 400 may not be disposable, the method and manner in which the contents of both the extender 400 and receptacle 50 are emptied may be similar to the methods described with respect to extender 100, 200, 300.

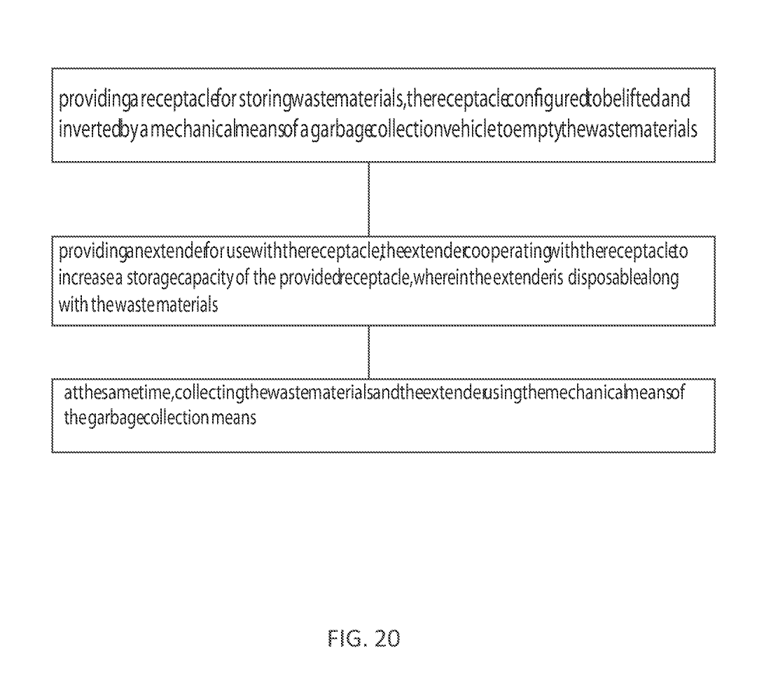

Referring now to FIGS. 1-19, and additional reference to FIG. 20, embodiments of a method for collecting garbage may include a step of providing a receptacle, such as receptacle 50, for storing waste materials. For example, a garbage collecting service may provide homeowners, users, renters, etc. with a receptacle 50 of a certain size, wherein the receptacle 50 may be configured to be lifted and inverted by a mechanical means of a garbage collection vehicle 1000 to empty the waste materials 15 within the receptacle 50. Another step may be to provide an extender 100, 200, 300 for use with the receptacle 50, the extender cooperating with the receptacle 50 to increase a storage capacity of the provided receptacle 50, wherein the extender 100, 200, 300 is disposable along with the waste materials 15. Another step may be collecting the waste materials 15 and the extender 100, 200, 300 at the same time, using the mechanical means of the garbage collection means 1000. For example, the extender 100, 200, 300 and the receptacle 50 may be emptied of waste materials in a same motion. This method may save labor time for the garbage collectors because a driver or operator(s) may stay in the truck and pick up the receptacle according to existing methods, yet dump the contents of the extender (and potentially the extender itself) in the same motion. Moreover, the method may allow customers to purchase a smaller trash service (e.g. smaller size container) with a temporary means in which to increase a capacity of the purchased receptacle. The disposability of the extender 100, 200, 300 may be a cost-effective alternative to buying a larger receptacle service, and may be a way for a garbage service collection company to secure more customers by including one or more extenders in a package.

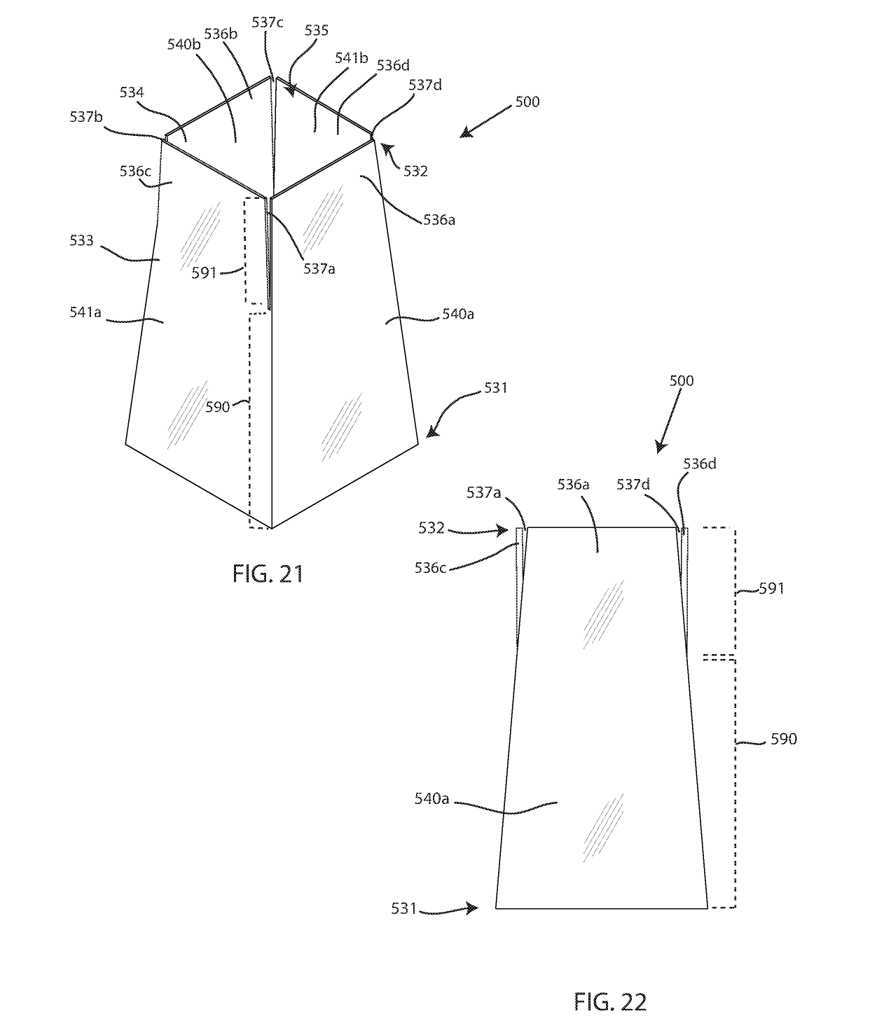

With continued reference to the figures, FIG. 21 depicts a perspective view of an embodiment of a receptacle support device 500. Embodiments of receptacle support device 500 may share the same or substantially the same structural and functional aspects of extender 100, 200, 300, and 400, including a first end 531, a second end 532, an outer surface 533, and inner surface 534, a general opening therethrough, and an interior space 535. The receptacle support device 500 may be an insert, a box, a tapered box, a tapered structure, a garbage containment unit, an add-on, a cardboard structure, a cardboard insert, a plastic structure, a biodegradable structure, a structure made from recycled materials, a cardboard accessory, or the like.

The receptacle support device 500 may have a plurality of walls 540a, 540b, 541a, 541b. Each of the plurality of walls 540a, 540b, 541a, and 541b may be shaped like a trapezoid to facilitate the tapered shape/configuration of the receptacle support device 500. In one embodiment, the receptacle support device 500 may include four walls, with a front wall 540a, a back wall 540b, a first side wall 541a, and a second side wall 541b. The walls 540a, 540b, 541a, and 541b may be equal in size, or may vary in size with respect to each other. Furthermore, the walls 540a, 540b, 541a, and 541b may be structurally integral with each other and joined along each edge to the next wall, as shown in FIG. 21. The edges may be creased or pre-creased to facilitate or promote flexibility of the receptacle support device 500. The flexibility of the receptacle support device 500 may vary, but in some cases, the receptacle support device 500 may be able to be folded into a flat unit, while all of the edges of the walls 540a, 540b, 541, and 541b remain connected, structurally integral or otherwise. It should be understood that the receptacle support device 500 is not limited to having a plurality of walls. For example, embodiments of receptacle support device 500 may be cylindrically shaped, and may be comprised of a single wall.

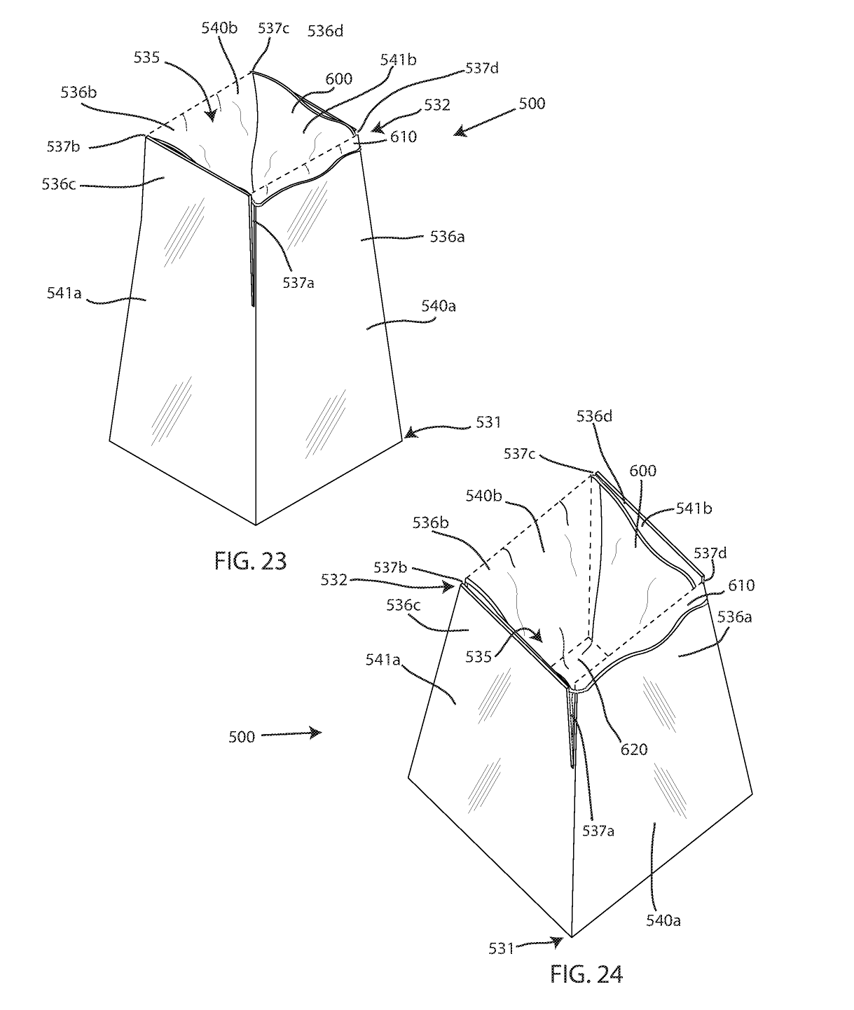

With reference to FIG. 21, each of the walls 540a, 540b, 541a, and 541b may be connected to each other from the first end 531 of the receptacle support device 500 to the second end 532 of the receptacle support device 500. Each of the walls 540a, 540b, 541a, and 541b may be connected for a length 590 that begins at the first end 531 of the receptacle support device 500 and ends at a point before the second end 532 of the receptacle support device 500. Embodiments of flaps 536a, 536b, 536c, and 536d as shown in FIG. 21 may be formed by one or more vertical slits 537a, 537b, 537c, and 537d extending from the second end 532 of the receptacle support device 500 a distance 591 towards the first end 532. The vertical slits 537a, 537b, 537c, and 537d may be perforations, or may be a continuous cut into the receptacle support device 500. The flaps 536a, 536b, 536c, and 536d may be folded pivotally towards the outer surface 533 of the receptacle support device 500 or folded pivotally towards the inner surface 534 of the receptacle support device 500 to accommodate garbage bags 600 (shown in FIG. 23) having open tops 610 (shown in FIG. 23) of various sizes and circumferences. Embodiments of the vertical slits 537a, 537b, 537c, 537d may permit a deflection of flaps 536a, 536b, 536c, 536d. For instance, a user may manipulate the flaps 536a, 536b, 536c, 536d by delivering a certain force, wherein the flaps 536a, 536b, 536c, 536d may maintain a rigid or otherwise upright position.

FIG. 22 depicts a side view of an embodiment of receptacle support device 500. Embodiments of the receptacle support device 500 may be tapered. For example, embodiments of the receptacle support device 500 may taper in a direction from the first end 531 to the second end 532.

Referring now to FIGS. 23 and 24, a manner in which a garbage bag 600 can be secured to the receptacle support device 500 such that the open top 610 of the garbage bag 600 is held open and the user can place items therein is now described. FIG. 23 depicts a first perspective view of an embodiment of receptacle support device 500, a garbage bag 600 having been placed into the interior space 535 of the receptacle support device. The closed bottom 620 of the garbage bag 600 has been placed into the interior space 535 of the receptacle support device 500 such that the closed bottom 620 of the garbage bag 600 is proximate to the first end 531 of the receptacle support device 500 and the open top 610 of the garbage bag is proximate to the second end 532 of the receptacle support device 500. In an exemplary embodiment, the open top 610 of the garbage bag 600 may be be folded over opposing flaps 536a and 536b, such that the garbage bag 600 is secured to the second end 532 of the receptacle support device 500. It should be understood that the garbage bag 600 could be secured to any single flap 536a, 536b, 536c, and 536d, or any combination of flaps 536a, 536b, 536c, and 536d. Further, embodiments of the flaps 536a, 536b, 536c, 536d may be a retaining structure for retaining at least a portion of the garbage bag 600.

FIG. 24 depicts a second perspective view of an embodiment of receptacle support device 500, a garbage bag 600 having been placed into the interior space 535 of the receptacle support device 500. The closed bottom 620 of the garbage bag 600 is proximate to the first end 531 of the receptacle support device 500 and the open top 610 of the garbage bag 600 has been folded over opposite flaps 536a and 536b such that the garbage bag 600 is secured to the second end 532 of the receptacle support device 500. It should be understood that the garbage bag 600 could be secured to any single flap 536a, 536b, 536c, 536d, or any combination of flaps 536a, 536b, 536c, and 536d

It should be understood that a garbage bag 600 is not limited to being located in the interior space 535 of the receptacle support device 500. For example, the garbage bag 600 could be secured to flap 536a such that the garbage bag 600 is exterior and adjacent to side 540a of the receptacle support device 500 with a portion of the open top 610 of the garbage bag folded over flap 536a of the receptacle support device 500. As another example, a separate garbage bag 600 could be secured to each flap 536a, 536b, 536c, and 536d of the receptacle support device 500. In this way, the user could designate a different garbage bag 600 secured to each flap 536a, 536b, 536c, and 536d of the receptacle support device 500 for different categories of refuse, for example, recyclable materials, organic refuse, plastics, aluminum cans, and the like. As another example, the flaps 536a, 536b, 536c, 536d, could each be pivotally folded into the interior space 535 of the receptacle support device 500 such that the open top 610 of the garbage bag 600 may be folded over the folds of flaps 536a, 536b, 536c, and 536d in order to provide more structural support when the user is placing heavy items into the garbage bag 600.

Accordingly, embodiments of the receptacle support device 500 may provide a stand-alone garbage receptacle, wherein a liner or garbage bag 600 is placed therein. The receptacle support device 500 may be sold as a flat or substantially flat unit (e.g. folded over one or more times), wherein a user unfolds the device 500 and lines the interior region 535 with a garbage bag 600. The receptacle support device 500 may be disposable, such that the receptacle support device 500 may be disposed along with the contents placed within the interior space 535.

The garbage bag 600 is not limited to being secured to the receptacle support device 500 by means of the open top 610 of the garbage bag 600 being folded over one or more of the flaps 536a, 536b, 536c, and 536d of the receptacle support device 500. For example, the garbage bag 600 could be affixed, attached, or adhered with glue, hooks, VELCRO® brand hook-and-loop fasteners, tacks, connected, magnetized, and the like. Further, the garbage bag 600 is not limited to being placed into the interior space 535 of the receptacle support device 500 through the second end of the receptacle support device 500 for example, the receptacle support device 500 may be inverted, and the flaps 536a, 536b, 536c, and 536d may be pivotally folded towards the outer surface 533 to provide support for the second end 532 of the receptacle support device 500 to rest on a surface, and a garbage bag 600 may be placed into the interior space 535 through the first end 531. The open top 610 of the garbage bag could then be folded over the first end 531 of the receptacle support device 500 thereby securing the open top 610 to the receptacle support device 500 in an open position.

In another embodiment, the receptacle support device 500 and garbage bag 600 may be sold as a kit. The receptacle support device may come with a single garbage bag 600, or a plurality of garbage bags 600 pre-affixed thereto such that the user can fill a garbage bag 600, and remove the garbage bag 600 from the receptacle support device 500, for example, by perforations, or by removing the garbage bag 600 from hooks, adhesive, or the like on the receptacle support device 500, to reveal another garbage bag 600 pre-affixed to the receptacle support device 500.

It should be understood that the receptacle support device 500 is not limited to receiving garbage bags 600. For example, the interior space 535 of the receptacle support device 500 could receive plastic grocery store bags, canvas bags, cloth bags, mesh bags, plastic containers, biodegradable containers, synthetic containers, and the like.

Referring now to FIGS. 21-24, embodiments of a method for using the receptacle support device 500 may include a step of providing a receptacle support device 500. For example, a user may purchase a receptacle support device 500 for use indoors or outdoors. Another step may be to place the receptacle support device 500 onto a flat surface such that the first end 531 is adjacent to the flat surface. Another step may be placing a garbage bag 600 into the interior space 535. Another step may be folding the open top 610 of the garbage bag 600 around one or more of the flaps 536a, 536b, 536c, 536d to secure the garbage bag 600 to the receptacle support device 500 such that the open top 610 is secured in an open position. Another step may be placing garbage, recyclables, other refuse, and the like into the garbage bag 600. Another step may be removing the open top 610 of the garbage bag 600 from the one or more flaps 536a, 536b, 536c, and 536d and lifting the garbage bag 600 out of the interior space 535. Another step may be removing the garbage bag 600 from the interior space 535 of the receptacle support device 500 by lifting the receptacle support device 500 off of the flat surface and over the garbage bag 600. Another step may be placing the receptacle support device 500 into a receptacle, for example, with reference to FIG. 1, receptacle 50, for use as an extender, for example, extender 100, 200, 300, and 400.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A receptacle support device comprising:
a plurality of walls, each wall of the plurality of walls being tapered from a first end of the receptacle support device to a second end of the receptacle support device, the plurality of walls being joined together to define an interior space for receiving waste materials;
at least one vertical slit, the at least one vertical slit permitting the plurality walls to be folded towards or away from the interior space; and
a garbage container, having an opening for receiving waste materials;
wherein the interior space of the receptacle support device is configured to receive the garbage container; and
wherein the opening of the garbage container is securable to the first end of the receptacle support device;
wherein the opening of the garbage container is held in an open position by the receptacle support device.

2. The receptacle support device of claim 1, wherein the garbage container is a plastic garbage bag.

3. The receptacle support device of claim 1, wherein the receptacle support device is disposable.

4. The receptacle support device of claim 1, wherein the garbage container is secured to a surface of one or more of the plurality of walls.

5. The receptacle support device of claim 1, wherein the receptacle support device is biodegradable.

6. The receptacle support device of claim 1, wherein the garbage container is biodegradable.

7. A method for collecting garbage, comprising:
providing a receptacle support device for securing a garbage container thereto, the receptacle support device including a plurality of walls, each wall of the plurality of walls being tapered from a first end of the receptacle support device to a second end of the receptacle support device, the plurality of walls being joined together to define an interior space for receiving waste materials, at least one vertical slit, the at least one vertical slit permitting the plurality walls to be folded towards or away from the interior space;
wherein a garbage container having an opening configured to receive waste materials is attachable to the receptacle support device,
wherein the opening of the garbage container is secured to the receptacle support device through interaction with one or more flaps created by the one or more vertical slit, such that the opening of the garbage container is held in an open position by the receptacle support device,
wherein waste materials are placed into the opening of the garbage container, and the garbage container is structurally supported by the receptacle support device.

8. The receptacle support device of claim 5, wherein the garbage container is a plastic garbage bag.

9. The receptacle support device of claim 5, wherein the receptacle support device is disposable.

10. The receptacle support device of claim 5, wherein the garbage container is secured to a surface of one or more of the plurality of walls.

11. The receptacle support device of claim 1, wherein the garbage container is secured to a surface of one or more of the plurality of walls.

12. The receptacle support device of claim 1, wherein the receptacle support device is biodegradable.

13. A receptacle support device comprising:
a plurality of walls, each of the plurality of walls being tapered from a first end of the receptacle support device to a second end of the receptacle support device, the plurality of walls being joined together to define an interior space for receiving waste materials; and
at least one vertical slit proximate the first end of the receptacle support device, the at least one vertical slit permitting a portion of one or more of the plurality walls to be folded towards or away from the interior space;
wherein the first end is configured such that the receptacle support device secures a garbage container such that the garbage container remains in an open position,
wherein the second end is configured such that the receptacle support device stands upright thereon with no assistance of an external force, structurally supporting the garbage container.

14. The receptacle support device of claim 9, wherein the garbage container is a plastic garbage bag.

15. The receptacle support device of claim 9, wherein the receptacle support device is disposable.

16. The receptacle support device of claim 9, wherein the garbage container is secured to a surface of one or more of the plurality of walls.

17. The receptacle support device of claim 1, wherein the garbage container is secured to a surface of one or more of the plurality of walls.

18. The receptacle support device of claim 1, wherein the receptacle support device is biodegradable.
